(19) United States
(12) Patent Application Publication
(10) Pub. No.: US 2012/0170791 A1
(43) Pub. Date: Jul. 5, 2012

(54) MICRO-SPEAKER

(75) Inventor: Yi-Ming MENG, Shenzhen (CN)

(73) Assignee: AAC ACOUSTIC TECHNOLOGIES (SHENZHEN) CO., LTD., Shenzhen (CN)

(21) Appl. No.: 13/190,451

(22) Filed: Jul. 25, 2011

(30) Foreign Application Priority Data
Dec. 30, 2010 (CN) 201020691750.5

(51) Int. Cl. H04R 1/02

(52) U.S. Cl. 381/386

(57) ABSTRACT

A micro-speaker is disclosed. The micro-speaker includes a frame defining a hollow space, a diaphragm attached to the frame, a voice coil positioned on the diaphragm, a cover covering the diaphragm and attached to the frame forming a housing, a yoke received in the hollow space and attached to the frame, a magnet received in the yoke, and a pole plate attached on the magnet. The yoke includes a bottom wall, and two ends of the base wall are provided with a groove corresponding to the magnetic gap, respectively. A width of the groove is greater than that of the thickness of the voice coil.

### FIELD OF THE INVENTION

The present disclosure relates to transducers to be mounted in terminal equipments for converting electrical signals to audible sounds, and more particularly to a micro-speaker.

### DESCRIPTION OF RELATED ART

Sound which can be heard by a person's auditory sense is transmitted in the form of waves. The sound having the wave form moves air molecules and vibrates the tympanic membrane, thus allowing a person to hear the sound. In order to provide audible sounds, various kinds of speakers have been developed. The speaker is generally coupled to audio equipment or an amplifier for use as a large sound producing means for considerably amplifying volume. Alternatively, the speaker may be used as a small sound producing means having small size and volume.

As such, the small-sized speaker may be mounted to a small electronic product, such as a mobile phone, a PDA, or a notebook computer. As the wireless age begins, consumers want to consume various contents regardless of time and place and demand portability. In order to satisfy the consumers' desires, speakers are tending towards miniaturization and lightness.

A micro-speaker related to the present disclosure includes a case defining a sound hole, a frame attached to the case for forming a chamber, a magnetic circuit defining a magnetic gap, a diaphragm located in the chamber, and a voice coil attached to the bottom of the diaphragm. Typically, the magnetic circuit includes a yoke, a magnet positioned on the yoke, and a top plate attached to the magnet. The magnetic gap is formed between the yoke and the magnet, and the voice coil is suspended in the magnetic gap. While electrified, the voice coil will be activated to vibrate by the electromagnetic Ampere Force and further drives the diaphragm to vibrate, which converts the electrical signals to sound waves. However, as mentioned above, as the micro-spacer is designed smaller and thinner, no extra space is provided for the voice coil to vibrate with sufficient amplitude.

Therefore, it is desirable to provide a speaker which can overcome the above-mentioned problems.

### BRIEF DESCRIPTION OF THE DRAWINGS

FIG. 1 is an isometric exploded view of a micro-speaker in accordance with an exemplary embodiment of the present invention;

FIG. 2 is an illustrative cross-sectional view of the micro-speaker in FIG. 1,

FIG. 3 is an isometric view of a yoke of the micro-speaker in FIG. 1.

Many aspects of the embodiment can be better understood with reference to the drawings mentioned above. The components in the drawings are not necessarily drawn to scale, the emphasis instead being placed upon clearly illustrating the principles of the present disclosure. Moreover, in the drawings, like reference numerals designate corresponding parts throughout the several views.

### DETAILED DESCRIPTION OF THE EXEMPALRY EMBODIMENT

Reference will now be made to describe an exemplary embodiment of the present disclosure in detail.

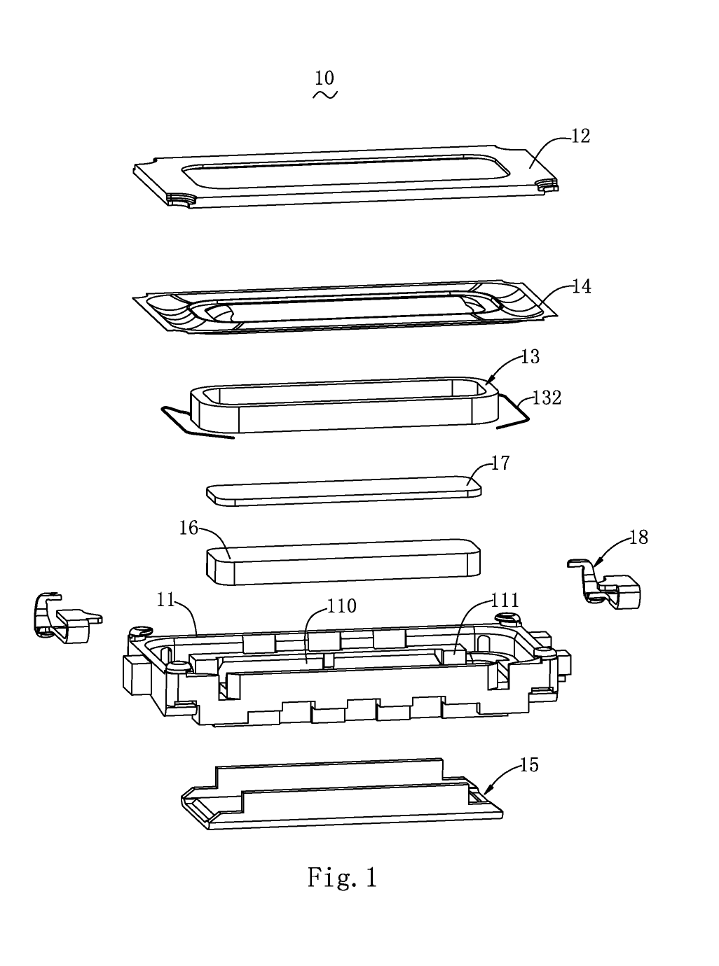

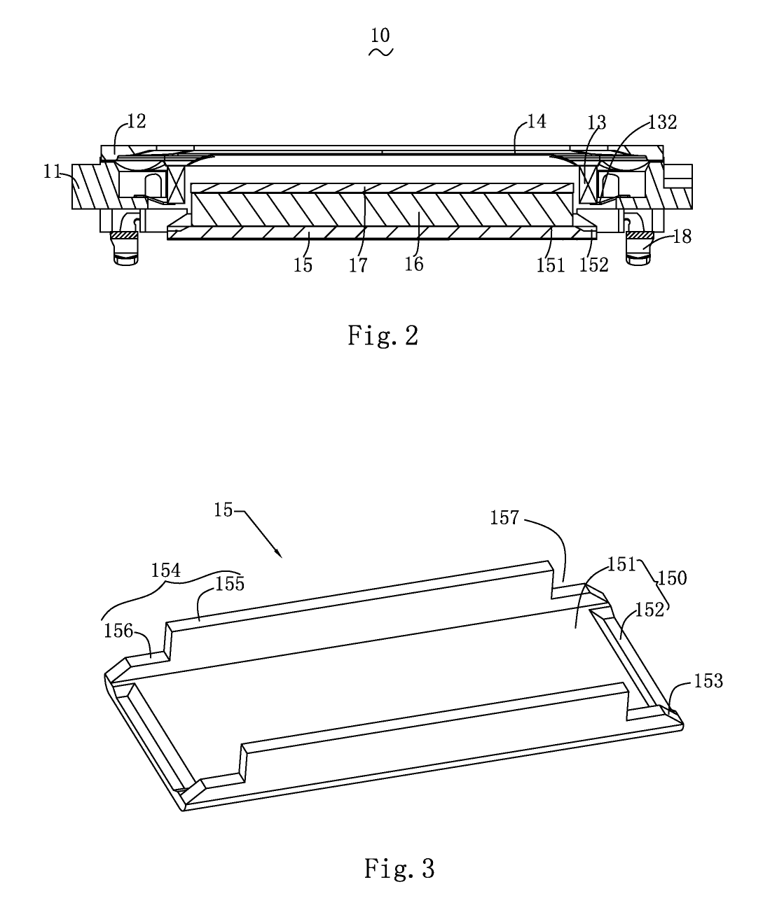

Referring to FIGS. 1-2, a micro-speaker 10 comprises a frame 11 forming a hollow space 110, a diaphragm 14 attached to the frame 11, a cover 12 covering the diaphragm 14 and attached to the frame 11, a yoke 15 engaged with the frame 11, a magnet 16 received in the yoke 15, a pole plate 17 attached on the magnet 16, and a voice coil 13 activating the diaphragm 14. Further, a pair of conductive terminals 18 is provided in the frame electrically connected to a leads 132 of the voice coils 13. Thus, the voice coils 13 can receive electrical signals via the conductive terminals 18. A magnetic gap is formed between the yoke 15 and the magnet 16. In addition, the frame 11 further defines a plurality of positioning portions 111 extending from inner sidewalls thereof.

The frame 11, cooperatively with the cover 12, defines a chamber therebetween for receiving the yoke 15, the magnet 16, the pole plate 17, the voice coil 13 and the diaphragm 14 therein. While electrified, the voice coil 13 is activated to move by Lorenz Force, and accordingly, the diaphragm 14 is driven by the voice coil 13, which produces sound waves.

Referring to FIG. 3, the yoke 11 includes a base wall 151, a pair of longitudinal sidewalls 154 extending upwardly and perpendicularly from the longitudinal outer periphery of the base wall 151. Each of the longitudinal sidewalls 154 comprises a main wall 155 and a pair of auxiliary walls 156 extending from two ends of the main wall 155, respectively. A height of the main wall 155 is greater than that of the auxiliary walls 156. An inclining portion 153 extends from the auxiliary wall 156.

Accordingly, each of the longitudinal sidewalls 154 further comprises a nick 157 formed by the main wall 155 and the auxiliary wall 156 for engaging with the positioning portion 111 for positioning the frame 11. Each of the two ends of the base wall 151 is provided with a groove 152 located between two main walls 15 and closed to the inclining portions 153.

While assembled, the voice coil 13 can be partially received in the magnetic gap and is suspended above the groove 152. In order not to limit the vibration of the voice coil 13 completely, the groove 152 is designed to have a width greater than that of the thickness of the voice coil 13.

While vibrating, the voice coil 13 is intermittently received in the magnetic gap for avoiding dump the base wall 151 of the yoke 15.

While the present invention has been described with reference to the specific embodiment, the description of the invention is illustrative and is not to be construed as limiting the invention. Various of modifications to the present invention can be made to the exemplary embodiment by those skilled in the art without departing from the true spirit and scope of the invention as defined by the appended claims.

What is claimed is:

1. A micro-speaker, comprising:
a frame forming a hollow space;
a diaphragm attached to the frame;
a yoke received in the hollow space and attached to the frame;
a magnet received in the yoke, a pole plate attached on the magnet and forming a magnetic gap together with the yoke;
a voice coil activating the diaphragm, and partially inserted into the magnetic gap; wherein
the yoke defines a base wall, and two ends of the base wall are provided with a groove corresponding to the magnetic gap, respectively.

2. The micro-speaker as described in claim 1, wherein the yoke further defines a pair of longitudinal sidewalls extending upwardly and perpendicularly from the longitudinal outer periphery of the base wall.

3. The micro-speaker as described in claim 2, wherein each of the longitudinal sidewalls defines a main wall, a pair of auxiliary wall extending from two ends of the main wall, and a pair of inclining portions extending from the auxiliary wall.

4. The micro-speaker as described in claim 1, wherein the frame defines a positioning portion extending from inner sidewalls of the frame and received in the hollow space.

5. The micro-speaker as described in claim 3, wherein a nick is formed by the main wall and the auxiliary wall for engaging with the positioning portion.

6. The micro-speaker as described in claim 1, wherein a width of the groove is greater than that of the thickness of the voice coil.

7. A micro-speaker, comprising:
a frame defining a chamber formed by a plurality of inner walls;
a yoke received in the chamber;
a magnet located on the yoke;
a pole plate located above the magnet;
a magnetic gap formed between the magnet and the yoke;
a voice coil partially received in the magnetic gap;
a diaphragm driven by the voice coil for producing sound waves; wherein
the yoke defines a base wall, a pair of sidewalls extending parallel to each other, a recess formed in the base wall and between the two sidewalls for providing the voice coil with extra vibration space.

8. The micro-speaker as described in claim 7, wherein each of the side walls of the frame includes a main wall and a pair of auxiliary walls extending from two ends of the main wall.

9. The micro-speaker as described in claim 8, wherein the main wall has a height greater than a height of the auxiliary wall thereby forming a nick.

10. The micro-speaker as described in claim 8, wherein the frame further defines a positioning portion extending from the inner walls for engaging with the nick.

11. The micro-speaker as described in claim 8, wherein the auxiliary wall defines an inclining portion extending toward the base wall.
